(19) United States
(12) Patent Application Publication
(10) Pub. No.: US 2012/0268569 A1
(43) Pub. Date: Oct. 25, 2012

(54) COMPOSITE CAMERA SYSTEM

(75) Inventor: Mitsuaki KUROKAWA, Osaka (JP)

(73) Assignee: SANYO ELECTRIC CO., LTD., Moriguchi-city (JP)

(21) Appl. No.: 13/447,556

(22) Filed: Apr. 16, 2012

(30) Foreign Application Priority Data
Apr. 19, 2011 (JP) 2011-093401

(51) Int. Cl. H04N 13/02

(52) U.S. Cl. 348/47; 348/E13.074

(57) ABSTRACT

An aspect of the invention provides a composite camera system that comprises a first camera including a first imaging unit; a second camera including a second imaging unit; a mount unit configured to detachably mount thereon the first camera and the second camera, wherein scenes captured by the first imaging unit and second imaging unit in a mounted state coincide with each other in vertical position; and a creation unit configured to create a three-dimensional image on the basis of images representing the scenes captured by the first imaging unit and the second imaging unit in the mounted state.

### CROSS REFERENCE TO RELATED APPLICATIONS

This application claims priority based on 35 USC 119 from prior Japanese Patent Application No. 2011-093401 filed on Apr. 19, 2011, entitled “COMPOSITE CAMERA SYSTEM”, the entire contents of which are incorporated herein by reference.

### BACKGROUND OF THE INVENTION

1. Field of the Invention

The invention relates to a composite camera system. In particular, the invention relates to a composite camera system capable of performing image processing based on images of an object taken from angles different from each other.

2. Description of Related Art

Camera systems used with a video camera and a LCD monitor separated from each other are disclosed as related arts. Some of those allows a user to check images on the LCD monitor which are being shot or replayed by the video camera, and to control operations of the video camera by manipulating the LCD monitor.

In above camera systems, however, even separated from each other, the video camera and the LCD monitor must be used as one unit and cannot be used independently of each other. This may lead to a reduction in versatility.

### SUMMARY OF THE INVENTION

An aspect of the invention provides a composite camera system that comprises: a first electronic camera including a first imaging unit; a second electronic camera including a second imaging unit; a mount unit on which the first electronic camera and the second electronic camera are mounted detachably, wherein when the first electronic camera and the second electronic camera are mounted on the mount unit, a vertical position of a scene captured by the first imaging unit coincides with a vertical position of a scene captured by the second imaging unit; and a creation unit configured to create a three-dimensional image on the basis of an image representing the scene that is captured by the first imaging unit and an image representing the scene that is captured by the second imaging unit when the first electronic camera and the second electronic camera are mounted on the mount unit.

Another aspect of the invention provides a composite camera system that comprises a first camera detachably mountable on the composite camera system, the first camera comprising a first imaging unit, a first interface that transfers, to a second camera, first image data captured by the first imaging unit when connected to the second camera, and a first processor that controls the first imaging unit; the second camera comprising a second imaging unit, a mount unit that mounts the first camera thereon, wherein scenes captured by the first imaging unit and the second imaging unit in a mounted state coincide with each other in vertical position, a second interface connected to the first interface to receive the first image data in the mounted state, a second processor that controls the second imaging unit, and a creation unit that receives the first image data and second image data captured by the second imaging unit, and creates a three-dimensional image on the basis of the first image data and the second image data in the mounted state.

### BRIEF DESCRIPTION OF THE DRAWINGS

FIG. 1 is a block diagram illustrating the basic configuration of a composite camera system according to an embodiment.

FIG. 2 is a block diagram illustrating the configuration of the composite camera system according to the embodiment.

FIG. 3 is a diagram illustrating a part of the external appearance of a composite camera system in a disassembled state.

FIG. 4A is a diagram illustrating a part of the external appearance of a digital video camera, and FIG. 4B is a diagram illustrating another part of the external appearance of the digital video camera.

FIG. 5A is a perspective view illustrating a part of the external appearance of composite camera system in a folded state, and FIG. 5B is a perspective view illustrating a part of the external appearance of the composite camera system in a state where one of the digital video cameras is turned to the right side at 90 degrees.

FIG. 6A is a perspective view illustrating a part of the external appearance of the composite camera system in a state where the above-mentioned one of the digital video cameras having been turned to the right side at 90 degrees is further turned upwards, and FIG. 6B is a perspective view illustrating another part of the external appearance of the composite camera system in a state where the above-mentioned one of the digital video cameras having been turned to the right side at 90 degrees is further turned upwards.

FIG. 7 is a diagram illustrating an example of a scene captured by the composite camera system according to the embodiment illustrated in FIG. 2.

FIG. 8 is a diagram illustrating an example of an image created by the composite camera system according to the embodiment shown in FIG. 2.

FIG. 9 is a flowchart illustrating a part of the operational flow of a CPU included in the composite camera system according to the embodiment shown in FIG. 2.

### DETAILED DESCRIPTION OF EMBODIMENTS

Embodiments of the invention are explained with referring to drawings. In the respective drawings referenced herein, the same constituents are designated by the same reference numerals and duplicate explanation concerning the same constituents is basically omitted. All of the drawings are provided to illustrate the respective examples only. No dimensional proportions in the drawings shall impose a restriction on the embodiments. For this reason, specific dimensions and the like should be interpreted with the following descriptions taken into consideration. In addition, the drawings include parts whose dimensional relationship and ratios are different from one drawing to another.

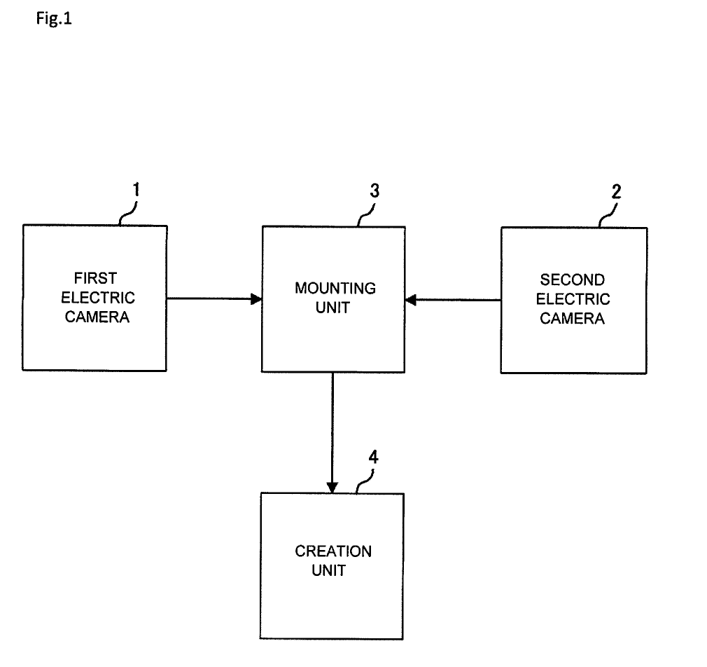

FIG. 1 illustrates the basic configuration of a composite camera system according to an embodiment. First electronic camera 1 includes a first imaging unit, whereas second electronic camera 2 includes a second imaging unit. Mounting unit 3 detachably mounts first electronic camera 1 and second electronic camera 2 thereon such that scenes captured by the first and second imaging units in the mounted state can coincide with each other in vertical position. Creation unit 4 creates a three-dimensional (3D) image based on images representing the scenes captured by the first and second imaging units in the mounted state.

First electronic camera 1 and second electronic camera 2 include their respective imaging units, and thus are capable of creating two-dimensional images independently of each other. First electronic camera 1 and second electronic camera 2 are mounted on mount unit 3 such that the scenes captured by the first and second imaging units in the mounted state coincide with each other in the vertical position. In addition, a three-dimensional image is created on the basis of images captured by the first and second image units in the mounted state. In this way, versatility of the composite camera system can be increased.

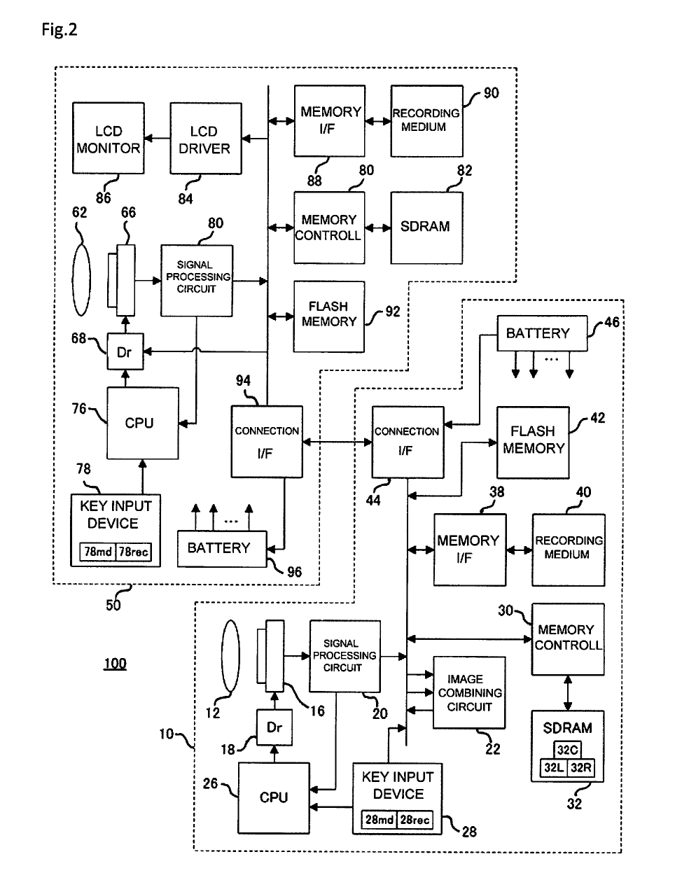

As shown in FIG. 2, composite camera system 100 of the embodiment includes digital video cameras 10 and 50.

Focus lens 62, image sensor 66, driver 68, signal processing circuit 80, LCD driver 84, LCD monitor 86, and processor (for example, CPU (Central processing unit)) 76, which are included in Digital video camera 50, are controlled basically by CPU 76, which is also included in Digital video camera 50. These components of digital video camera 50, however, are controlled by CPU 26, which is included in digital video camera 10, when digital video cameras 10 and 50 are connected together through connection interfaces (connection I/Fs) 44 and 94.

Digital video camera 10 includes battery 46. Battery 46 provides DC power supplies of various voltages to the entire system. Digital video camera 50 includes battery 96. Battery 96 provides DC power supplies of various voltages to the entire system. When digital video cameras 10 and 50 are connected together through connection I/Fs 44 and 94, battery 46 provides power supplies to battery 96 and thereby charges battery 96.

Digital video camera 10 includes focus lens 12. The optical image of a scene passed through focus lens 12 is applied onto the imaging plane of image sensor 16, where the optical image is subjected to photoelectric conversion. Thus, electric charges corresponding to the image representing the scene are generated in the imaging plane of image sensor 16.

Digital video camera 50 includes focus lens 62. The optical image of a scene passed through focus lens 62 is applied onto the imaging plane of image sensor 66, where the optical image is subjected to photoelectric conversion. Thus, electric charges corresponding to the image representing the scene are generated in the imaging plane of image sensor 66.

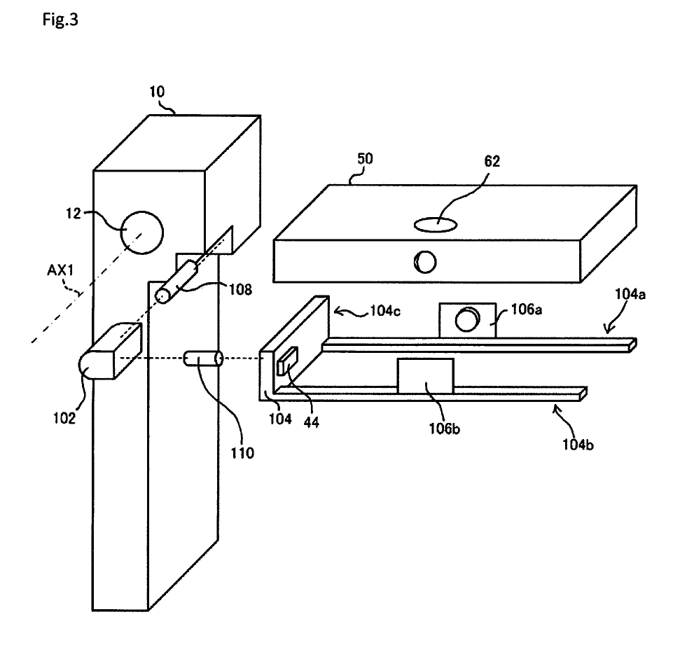

As shown in FIG. 3, digital video camera 50 is detachably connected to digital video camera 10 by means of joint 102 and stay 104. Focus lens 12 is provided in a front portion of digital video camera 10. Shaft 108 is provided in digital video camera 10 so that shaft 108 sticks out from a front portion of digital camera 10 and extends in parallel to optical axis AX1, which is normal to focus lens 12.

Joint 102 is supported by shaft 108 as described above. Joint 102 is rotatable about the axis of shaft 108. Shaft 110 is provided in joint 102 so that shaft 110 sticks out from joint 102 and extends in a direction normal to optical axis AX1. Stay 104 is supported by shaft 110 as described above, and is rotatable about the axis of shaft 110.

Connection I/F 44, and stoppers 106a and 106b are provided to stay 104. Stay 104 includes support units 104a and 104b, and joint unit 104c.

Joint unit 104c is in the shape of a vertically elongated plate with the surfaces located on the right side and on the left side being the principal surfaces. Connection I/F 44 is provided to stick out from a front portion of the left-side surface of the joint unit 104c. Each of support units 104a and 104b is in the shape of a horizontally elongated plate with the upper base surface being the principal surface. Support units 104a and 104b are provided to stick out respectively from two end portions in a lower portion of the left-side side surface of joint unit 104c. Stoppers 106a and 106b are provided respectively in central portions of support units 104a and 104b so that stoppers 106a and 106b face each other.

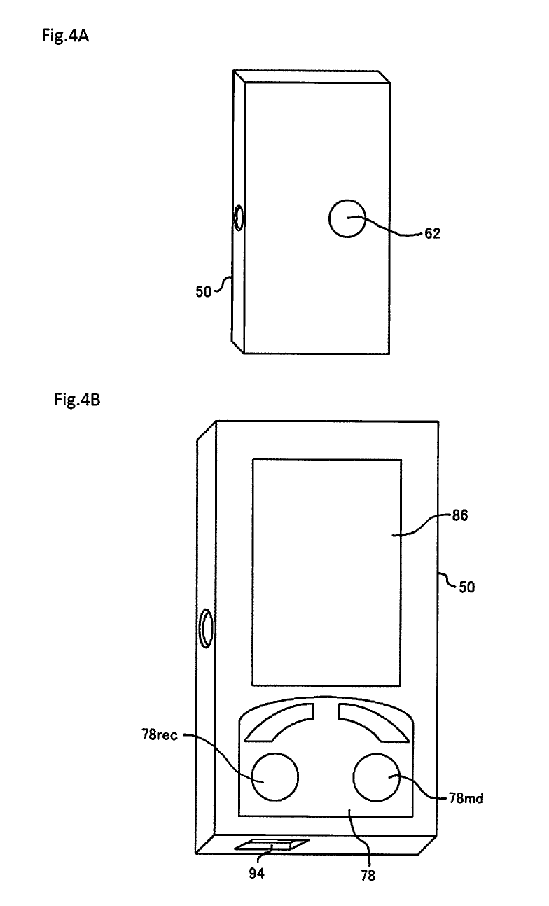

As shown in FIGS. 4A and 4B, digital video camera 50 includes connection I/F 94, and has a rectangular shape in this embodiment. Focus lens 62 is provided at a position slightly offset leftwards from the center in the front-side surface of digital video camera 50. Connection I/F 94 is provided in a basin formed in a left-side portion of the lower base surface of digital video camera 50. In addition, digital video camera 50 includes two holes formed respectively in the right side surface and the bottom side surface.

Referring back to FIG. 3, when connected to digital video camera 10, digital video camera 50 is mounted on the upper base surfaces of support units 104a and 104b with the front-side surface facing upwards and the lower base surface facing joint unit 104c. In this state, connection I/F 44 is fitted in connection I/F 94. Each of stoppers 106a and 106b has a protruding portion. The two protruding portions are fitted respectively in the two holes formed in digital video camera 50, and thereby digital video camera 50 is fixed to stay 104.

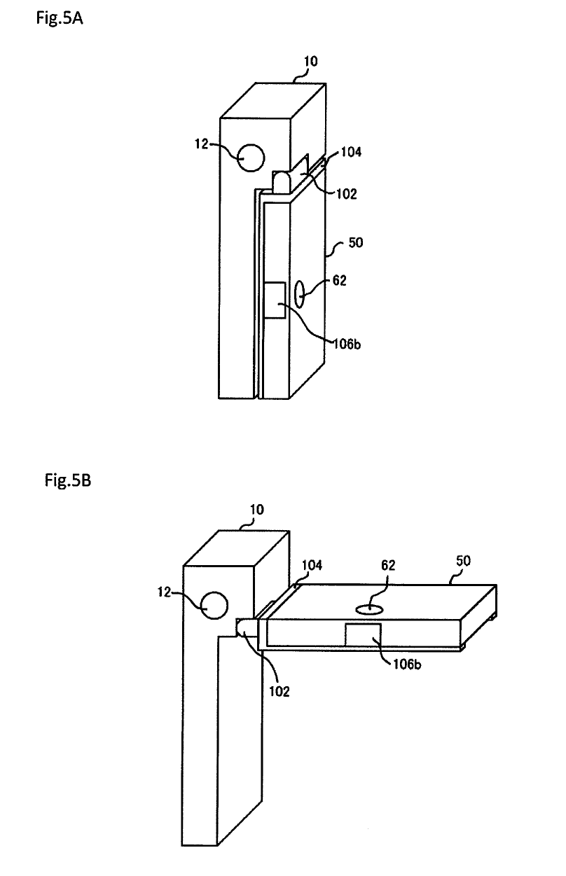

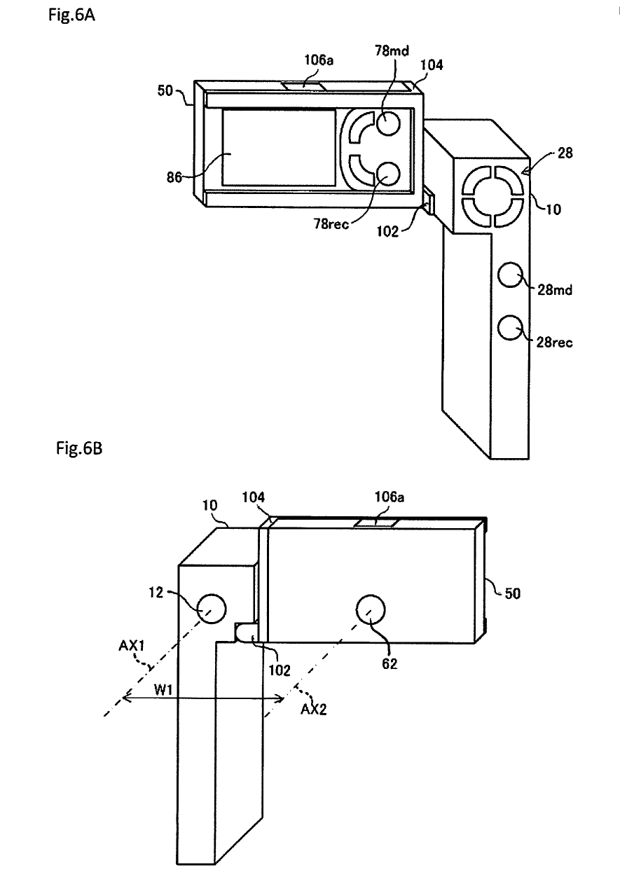

When composite camera system 100 is folded as shown in FIG. 5A, digital video camera 50 is laid on the left side portion of digital video camera 10 with focus lens 62 being exposed out. In this state, when joint 102 is turned about the axis of shaft 108 by 90 degrees, digital video camera 50 and stay 104 change from their respective positions shown in FIG. 5A to those shown in FIG. 5B. Moreover, when stay 104 is turned about the axis of shaft 110 by 90 degrees, digital video camera 50 and stay 104 are turned upwards as shown in FIGS. 6A and 6B.

When digital video cameras 10 and 50 are connected together as shown in FIG. 6A, support units 104a and 104b are tightly fitted respectively to the right-side edge and to the left-side edge of the backside surface of digital video camera 50. In this state, LCD monitor 86 is exposed out between support units 104a and 104b.

When the composite camera system 10 is in a state shown in FIG. 6B, the front-side surface of digital video camera 10 and the front-side surface of digital video camera 50 are flush with each other. In this state, optical axis AX2 of focus lens 62 and optical axes AX1 are parallel to each other. In addition, when composite camera system 100 in this state is kept in a horizontal position, the vertical positions of optical axes AX1 and AX2 coincide with each other. In addition, the distance (=W1) between optical axes AX1 and AX2 in the horizontal direction is set to approximately 6 cm by taking account of the distance between eyes of a human being. Optical images passed through focus lenses 12 and 62 thus provided are used to record a 3D (three-dimensional) video image in the following way.

When composite camera system 100 is powered ON and when a 2D (two-dimensional) imaging mode is selected by means of mode set-up switch 28md provided in key-input device 28, CPU 26 starts a 2D imaging task. When a 3D (three-dimensional) imaging mode is selected by means of mode set-up switch 28md mentioned above, CPU 26 starts a 3D imaging task. When a playback mode is selected, CPU 26 starts a playback task.

When a 3D imaging task is started, CPU 26 starts driver 18 and driver 68 to capture movie images. In response to vertical synchronization signals Vsync, which are generated periodically, each of drivers 18 and 68 exposes the corresponding imaging plane to light, and thus electric charges are generated in the imaging plane. The generated electric charges are read in a raster scanning manner. Thereby raw image data representing the scene are repeatedly outputted from each of image sensors 16 and 66. In the following description, raw image data outputted from image sensor 16 are referred to as the “R-side raw image data.” In addition, raw image data outputted from image sensor 66 are referred to as the “L-side raw image data.”

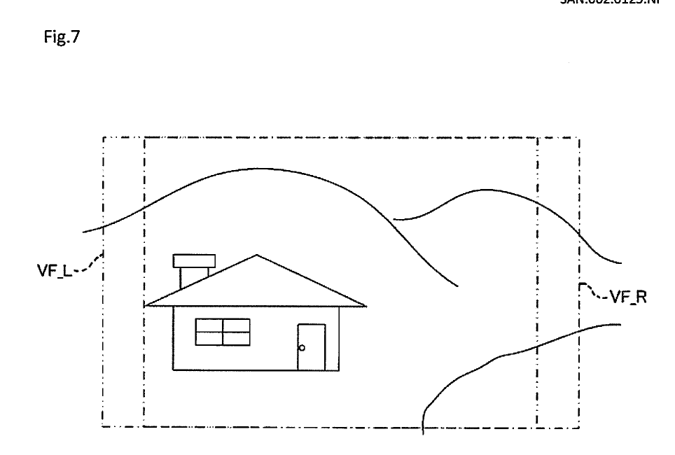

When a scene shown in FIG. 7 exists in front of composite camera system 100, image sensor 16 captures right-side visual field VF_R and image sensor 66 captures left-side visual field VF_L. Since the vertical positions of focus lenses 12 and 62 coincide with each other when composite camera system 100 is kept at a horizontal position, the vertical position of right-side visual field VF_R and that of left-side visual field VF_L coincide with each other although the horizontal position of right-side visual field VF_R and that of left-side visual field VF_L are slightly offset from each other. Accordingly, common visual field VF_C that is captured by both of image sensors 16 and 66 partially occupies right-side visual field VF_R and left-side visual field VF_L.

Referring back to FIG. 2, R-side raw image data outputted from image sensor 16 are sent to signal processing circuit 20, whereas L-side raw image data outputted from image sensor 66 are sent to signal processing circuit 80. Each of signal processing circuits 20 and 80 performs such processing on the provided raw image data as color separation, white balance adjustment, and YUV conversion. The image data in the YUV format are then written into SDRAM 32 through memory controller 30. R-side raw image data outputted from signal processing circuit 20 are stored in R-side image area 32R, whereas L-side raw image data outputted from signal processing circuit 80 are then stored in L-side image area 32L via connection I/Fs 44 and 94.

memory controller 30 specifies a cutout area, which corresponds to common visual field VF_C, in R-side image area 32R and L-side image area 32L. Image combining circuit 22 repeatedly reads a part of R-side raw image data belonging to the cutout area from R-side image area 32R through memory controller 30. In addition, image combining circuit 22 repeatedly reads a part of L-side raw image data belonging to the cutout area from L-side image area 32L through memory controller 30.

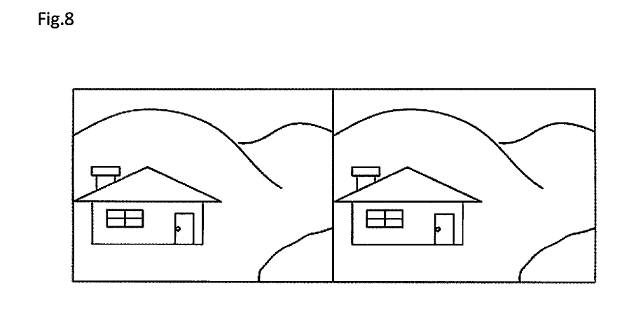

The read processing from R-side image area 32R and the read processing from L-side image area 32L are performed in a parallel fashion. Thus, R-side raw image data and L-side raw image data of the same frame are inputted concurrently into image combining circuit 22. Image combining circuit 22 synthesizes the R-side raw image data and the L-side raw image data thus inputted together to create a 3D image data (see FIG. 8). The created 3D image data of each frame are written into composite-image area 32C in SDRAM 32 through memory controller 30.

LCD driver 84 repeatedly reads the 3D image data stored in composite-image area 32C via connection I/Fs 44 and 94. On the basis of the read 3D image data, LCD driver 84 drives LCD monitor 86. As a consequence, a real-time movie image (through-the-lens image) representing common visual field VF_C is displayed on the monitor screen.

When an operation for starting the recording is performed through recording button 28rec, which is provided in key-input device 28, CPU 26 instructs memory I/F 38 to start a movie recording processing. Memory I/F 38 creates a new movie file in recording medium 40 (and opens the newly created movie file) . Memory I/F 38 repeatedly reads the 3D image data stored in composite-image area 32C of SDRAM 32 through memory controller 30, and then writes the read 3D image data into the new movie file opened as described above.

When an operation for finishing the recording is performed through recording button 28rec, CPU 26 instructs memory I/F 38 to finish the movie recording processing. Memory I/F 38 finishes the read of the 3D image data from composite-image area 32C, and closes the movie file having been opened as described above. In this way, a 3D movie image in a certain file format is recorded in recording medium 40.

Upon startup of a playback task, CPU 26 under the playback task designates the latest movie file recorded in recording medium 40 as the playback movie file, and performs a playback processing on the designated movie file. As a consequence, an optical image corresponding to the image data of the designated movie file is displayed on LCD monitor 86.

Through the operation of key-input device 28 by an operator, CPU 26 designates the previous movie file or the following movie file as the playback movie file. The designated movie file is subjected to a similar playback processing to the one described above, and thus the image displayed on LCD monitor 86 is updated.

When digital video cameras 10 and 50 are not connected together and when either the 3D imaging mode or the playback mode is selected through mode set-up switch 28md of digital video camera 10, the operator receives a warning indicating that the task corresponding to the selected mode cannot be executed.

When digital video cameras 10 and 50 are not connected together and when the 3D imaging mode is selected through mode set-up switch 78md of digital video camera 50, the operator receives a warning indicating that the 3D imaging task cannot be executed.

Referring back to FIG. 2, when digital video cameras 10 and 50 are not connected together and digital video camera 50 is powered ON, CPU 76 starts a 2D imaging task when the 2D imaging mode is selected through mode set-up switch 78md provided in key-input device 78. CPU 76 starts a playback task when the playback mode is selected.

When the 2D imaging task is started, CPU 76 starts driver 68 for the processing of capturing the movie. In response to vertical synchronization signals Vsync, which are generated periodically, driver 68 exposes the imaging plane to light, and thus electric charges are generated in the imaging plane. The electric charges are read in a raster scanning manner. Thereby raw image data representing the scene are repeatedly outputted from image sensor 66.

The raw image data outputted from image sensor 66 are sent to signal processing circuit 80. Signal processing circuit 80 performs such processing on the provided raw image data as color separation, white balance adjustment, and YUV conversion. The image data in the YUV format are then written into SDRAM 82 through memory controller 80.

LCD driver 84 repeatedly reads the raw image data stored in SDRAM 82. On the basis of the read raw image data, LCD driver 84 drives LCD monitor 86. As a consequence, a real-time movie image (through-the-lens image) is displayed on the monitor screen.

When an operation for starting the recording is performed through recording button 78rec provided in key-input device 78, CPU 76 instructs memory I/F 88 to start a movie recording processing. Memory I/F 88 creates a new movie file in recording medium 90 (and opens the newly created movie file) . Memory I/F 88 repeatedly reads the raw image data stored in SDRAM 82 through memory controller 80, and then writes the read raw image data into the new movie file opened as described above.

When an operation for finishing the recording is performed through recording button 78rec, CPU 76 instructs memory I/F 88 to finish the movie recording processing. Memory I/F 88 finishes the reading of the raw image data from SDRAM 82, and closes the movie file having been opened as described above. In this way, a movie image in a certain file format is recorded in recording medium 90.

When a playback task is started, CPU 76 under the playback task designates the latest movie file recorded in recording medium 90 as the playback movie file, and performs a playback processing focused on the designated movie file. As a consequence, an optical image corresponding to the image data of the designated movie file is displayed on LCD monitor 86.

Through the operation of key-input device 78 by an operator, CPU 76 designates the previous movie file or the following movie file as the playback movie file. The designated movie file is subjected to a similar playback processing to the one described above, and thus the image displayed on LCD monitor 86 is updated.

CPU 26 executes a 2D imaging task irrespective of whether digital video cameras 10 and 50 are connected together or digital video cameras 10 and 50 are disconnected from each other. In this case, an image representing a scene is captured through focus lens 12 and image sensor 16, the raw image data thus captured is stored in SDRAM 32, and the corresponding movie file is created in recording medium 40. When digital video cameras 10 and 50 are connected together, an image captured through focus lens 62 and image sensor 66 may be used as the image representing a scene. When digital video cameras 10 and 50 are disconnected from each other, the display processing of the through-the-lens image is omitted. Other processing of 2D imaging task is performed in the same manner as the processing of the above-described 2D imaging task performed by CPU 76.

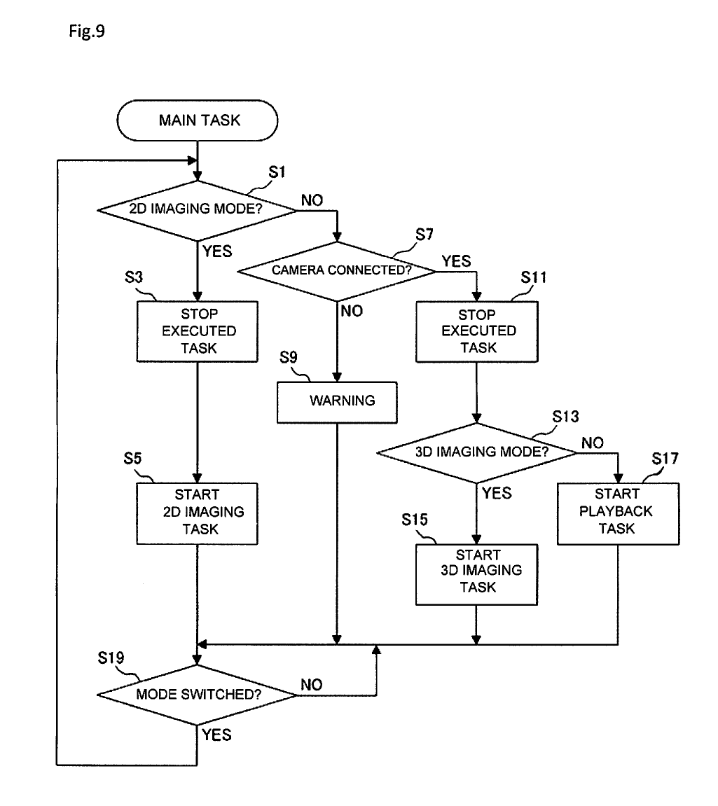

CPU 26 executes, in a parallel fashion, various tasks including the main task shown in FIG. 9. Note that the control programs corresponding to these tasks are stored in flash memory 42.

As shown in FIG. 9, whether or not the current operation mode is the 2D imaging mode is detected at step S1. When the detection result is NO, the process proceeds to step S7. In contrast, when the detection result is YES, the task being executed is stopped at step S3, and then a 2D imaging task is started at step S5.

At step S7, whether or not digital video cameras 10 and 50 are connected together is detected. When the detection result is YES, the process proceeds to step S11. In contrast, when the detection result is NO, a warning indicating that the task corresponding to the selected mode cannot be performed is given to the operator at step S9.

At step S11, the task being executed is stopped. Then, whether or not the current operation mode is the 3D imaging mode is detected at step S13. When the detection result is YES, a 3D imaging task is started at step S15. In contrast, when the detection result is NO, a playback task is started at step S17.

When the process at step S5, at step S9, at step S15, or at step S17 is finished, whether or not mode set-up switch 28md is operated is detected repeatedly at step S19. When the detection result is updated from NO to YES, the process returns to step S1.

As is understandable from the above description, digital video camera 10 includes image sensor 16, whereas digital video camera 50 includes image sensor 66. When connection I/Fs 44 and 94 are connected together, digital video cameras 10 and 50 are detachably connected together such that the scenes captured by image sensors 16 and 66 coincide with each other in the vertical position. When digital video cameras 10 and 50 are connected together, image combining circuit 22 creates a three-dimensional image on the basis of the image representing the scene captured by image sensor 16 and the image representing the scene captured by image sensor 66.

Having two image sensors, respectively, digital video cameras 10 and 50 are capable of creating two-dimensional images independently of each other. In addition, when digital video cameras 10 and 50 are connected together, the scenes respectively captured by the image sensors of digital video cameras 10 and 50 coincide with each other in vertical position. Furthermore, a three-dimensional image is created on the basis of the images representing the scenes captured by the two image sensors when digital video cameras 10 and 50 are connected together. In this way, versatility of the composite camera system can be increased.

Note that in the embodiment described above, L-side raw image data outputted from signal processing circuit 80 are stored in L-side image area 32L via connection I/Fs 44 and 94. LCD driver 84 repeatedly reads the 3D image data stored in composite-image area 32C via connection I/Fs 44 and 94. Alternatively, a wireless communication device may be provided in each of digital video cameras 10 and 50 to transfer image data mentioned above through wireless communication.

In addition, the movie file stored in recording medium 90 with digital video camera 50 being used independently may be transferred to recording medium 40 when digital video cameras 10 and 50 are connected together.

In addition, in the embodiment, the 3D image data are written in the movie file created in recording medium 40. Alternatively, a new movie file may be created in recording medium 90 and the 3D image data may be written in the movie file thus created in recording medium 90.

In addition, in the embodiment, while the 3D imaging task is being performed, LCD monitor 86 is driven on the basis of the 3D image data. Alternatively, LCD monitor 86 may be driven on the basis of any one of R-side raw image data and L-side raw image data, and thus LCD monitor 86 may display a through-the-lens image representing the one of right-side visual field VF_R and left-side visual field VF_L.

In addition, a display unit such as an electronic view finder may be provided in digital video camera 10. The display unit may be used to display a through-the-lens image when digital video cameras 10 and 50 are connected together or when digital video camera 10 is used independently.

In addition, in the embodiment, stay 104 is employed as an example of mounting unit 3. Alternatively, a connector may realize such that detachably mounts first electronic camera 1 and second electronic camera 2. The connector may be a connection I/F such that detachably mounts first electronic camera 1 and second electronic camera 2.

As has been described thus far, according to the embodiment, the first electronic camera and the second electronic camera include two imaging units, respectively, and therefore are capable of creating two-dimensional images independently of each other. The first electronic camera and the second electronic camera are mounted such that the scenes captured by the imaging units coincide with each other in vertical position. In addition, the three-dimensional image is created on the basis of the images representing the scenes captured individually by the image units. This can increase versatility of the composite camera system.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A composite camera system comprising:
a first electronic camera including a first imaging unit;
a second electronic camera including a second imaging unit;
a mount unit that detachably mounts thereon the first electronic camera and the second electronic camera, wherein scenes captured by the first imaging unit and second imaging unit in a mounted state coincide with each other in vertical position; and
a creation unit that creates a three-dimensional image on the basis of images representing the scenes captured by the first imaging unit and the second imaging unit in the mounted state.

2. The composite camera system of claim 1, further comprising a display unit that displays the three-dimensional image created by the creation unit.

3. The composite camera system of claim 2, wherein the display unit is provided in at least one of the first electronic camera and the second electronic camera.

4. The composite camera system of claim 1 further comprising a recording unit records, in a recording medium, the three-dimensional image created by the creation unit.

5. The composite camera system of claim 4, wherein the recording unit is provided in at least one of the first electronic camera and the second electronic camera.

6. The composite camera system of claim 1, wherein
the first electronic camera includes a first storage battery, and
the second electronic camera includes a second storage battery supplied with electric power from the first storage battery when the first electronic camera and the second electronic camera are mounted on the mount unit.

7. The composite camera system of claim 1, wherein the mount unit includes a folding mechanism.

8. The composite camera system of claim 7, wherein
the folding mechanism comprises
a joint that links the first electronic camera and the second electronic camera with each other,
a first shaft extending from the first electronic camera along an optical axis of the first imaging unit, and rotatably supporting the joint, and
a second shaft extending from the joint in a direction normal to the optical axis, and rotatably supporting the second camera.

9. The composite camera system of claim 1, wherein
the first electronic camera comprises
a first processing unit that processes the image representing the scene captured by the first imaging unit, and
a first operation key that operates a processing mode of the first processing unit, and
the second electronic camera comprises
a second processing unit that processes the image representing the scene captured by the second imaging unit, and
a second operation key that operates a processing mode of the second processing unit.

10. A composite camera system comprising:
a first camera detachably mountable on the composite camera system, the first camera comprising
a first imaging unit,
a first interface that transfers, to a second camera, first image data captured by the first imaging unit when connected to the second camera, and
a first processor that controls the first imaging unit;
the second camera comprising
a second imaging unit,
a mount unit that mounts the first camera thereon, wherein scenes captured by the first imaging unit and the second imaging unit in a mounted state coincide with each other in vertical position,
a second interface connected to the first interface to receive the first image data in the mounted state,
a second processor that controls the second imaging unit, and
a creation unit that receives the first image data and second image data captured by the second imaging unit, and creates a three-dimensional image on the basis of the first image data and the second image data in the mounted state.

11. The composite camera system of claim 10, wherein when the first camera is mounted on the second camera, control of the first imaging unit is switched from the first processor to the second processor.
